(19) United States
(12) Patent Application Publication
(10) Pub. No.: US 2025/0216261 A1
(43) Pub. Date: Jul. 3, 2025

(54) METHODS OF MULTISPECTRAL IMAGING AND PREDICTIVE ANALYSIS OF WOUNDS AND BURNS BASED ON MACHINE LEARNING AND RELATED SYSTEMS

(71) Applicant: East Carolina University, Greenville, NC (US)

(72) Inventors: Cheng Chen, Greenville, NC (US); Joffre Alvarez, Winterville, NC (US); Elizabeth Clarke, Greenville, NC (US); Megan Rosengarten, Weston, CT (US); Phil Hodges, Williamston, NC (US)

(21) Appl. No.: 19/008,902

(22) Filed: Jan. 3, 2025

Related U.S. Application Data
(60) Provisional application No. 63/617,171, filed on Jan. 3, 2024.

(51) Int. Cl. G01J 3/28; G06T 7/00

(52) U.S. Cl. CPC G01J 3/2823; G06T 7/0012; G01J 2003/2826

(57) ABSTRACT

Methodology of various imaging modalities and engineering features are provided for multispectral soft tissue imaging architecture. The architectural designs comprise hardware of multiple ranges of wavelength for illumination and camera sensing and software for image acquisition, processing, feature abstraction, artificial intelligence-machine learning (AI-ML) analysis, visualization, and reporting. Embodiments of imaging hardware in a medical device can include a light source of multiple bands of wavelength of noncoherent and coherent light for broadband, narrowband, fluorescence, autofluorescence, Laser Speckle Imaging (LSI), Laser Doppler Imaging (LDI), tissue oxygenation imaging, and other variation of soft tissue imaging modalities. The imaging software can include temporally and spatially synchronized acquisition of multiple imaging channels, image processing based on physics principle and mathematical equations of each imaging modality, feature engineering to abstract key parameters, AI-ML training and predictive analysis, image fusion-based visualization and report. The system is designed to be either an addon to smart phones, tablets or independent handheld equipment based on embedded System On Module (SOM).

### CLAIM OF PRIORITY

The present application claims the benefit of and priority to U.S. Provisional Application No. 63/617,171, filed on Jan. 3, 2024 entitled Methods of Multispectral Imaging and Predictive Analysis of Wounds and Burns Based on Machine Learning, the content of which is hereby incorporated herein by reference as if set forth in its entirety.

### FIELD

The present inventive concept relates to projecting light of multiple bands of wavelength onto a target such as tissues or organs with embedded blood vessels and capturing multiple channels of images in a temporally and spatially synchronized fashion for image processing, analysis, visualization, and reporting.

### BACKGROUND

Treatment and care for burn injuries is both resource and labor intensive. The current standard of care for burn and wound assessments largely relies on visual clinical judgement based on experience. Studies have shown that trained burn specialists have only an accuracy of 70% in their visual clinical judgement while front line emergency physicians function with just 50% accuracy in their capacity. Wound healing is a complex process and posts a major issue for patients with burn wounds and diabetic ulcers. Management of chronic wounds is a challenge to the healthcare system.

Multispectral technologies allow combining light of visible light, ultraviolet (UV) and near infrared (NIR) wavelengths during the imaging process and provide benefits of visualizing anatomical structure and quantitively visualizing distribution of functional, physiologic and compositional characteristics of organs and tissues.

Artificial Intelligence (AI) feature engineering and machine learning (ML) models using deep neural networks are becoming a powerful tool in image analytics, classification, and prediction. Training data teaches neural networks and helps improve their accuracy over time, thereby providing advantages and continuously improving accuracy benefits over human vision recognition and judgement. Most available AI/ML wound healing predictive models are based on visible color image or spectral bands which are insufficient in evaluating the wound healing process due to overlooking the important factors such as tissue blood flow and oxygen information. Accordingly, improved systems are desired.

### SUMMARY

Some embodiments of the present inventive concept provide methodology of various imaging modalities and engineering features are provided for multispectral soft tissue imaging architecture. The architectural designs comprise hardware of multiple ranges of wavelength for illumination and camera sensing and software for image acquisition, processing, feature abstraction, artificial intelligence-machine learning (AI-ML) analysis, visualization, and reporting. Embodiments of imaging hardware in a medical device can include a light source of multiple bands of wavelength of noncoherent and coherent light for broadband, narrowband, fluorescence, autofluorescence, Laser Speckle Imaging (LSI), Laser Doppler Imaging (LDI), tissue oxygenation imaging, and other variation of soft tissue imaging modalities. The imaging software can include temporally and spatially synchronized acquisition of multiple imaging channels, image processing based on physics principle and mathematical equations of each imaging modality, feature engineering to abstract key parameters, AI-ML training and predictive analysis, image fusion-based visualization and report. The system is designed to be either an addon to smart phones, tablets or independent handheld equipment based on embedded System On Module (SOM).

### BRIEF DESCRIPTION OF THE DRAWINGS

FIG. 1 is a chart illustrating spectral features of a multispectral imaging system and its imaging modalities in accordance with some embodiments of the present inventive concept.

FIG. 2 is a concept design diagram of an addon multispectral imaging system to a mobile device (for example, iPad Pro) in accordance with some embodiments of the present inventive concept.

FIG. 3 is a diagram illustrating three example options of an illumination layout in accordance with some embodiments of the present inventive concept

FIG. 4 is a diagram illustrating three options of camera sensing design in accordance with some embodiments of the present inventive concept.

FIG. 5 is a diagram illustrating major software modules in accordance with some embodiments of the present inventive concept.

FIG. 6 is a diagram illustrating an image data processing flow chart in accordance with some embodiments of the present inventive concept.

FIG. 7 is a diagram illustrating an architecture of convolutional neural network for image classification and segmentation in accordance with some embodiments of the present inventive concept.

FIG. 8 is diagram illustrating a workflow of multispectral image segmentation in wound care application in accordance with some embodiments of the present inventive concept.

FIG. 9 is a diagram illustrating a workflow of multispectral image predictive analysis in wound care application in accordance with some embodiments of the present inventive concept.

FIGS. 10A and 10B are diagrams illustrating an example of machine learning driven tissue separation from non-tissue background in accordance with some embodiments of the present inventive concept.

FIGS. 11A through 11C are diagrams illustrating an example of machine learning driven burn segmentation in accordance with some embodiments of the present inventive concept.

FIG. 12 is a diagram illustrating an example of machine learning driven burn segmentation in accordance with some embodiments of the present inventive concept(s).

FIGS. 13A and 13B are diagrams illustrating an example of clinical workflow using machine learning driven multispectral image analysis in accordance with some embodiments of the present inventive concept.

FIG. 14 is a diagram illustrating multiple concepts of form factors for present handheld imaging device in accordance with some embodiments of the present inventive concept(s).

FIG. 15 is a diagram illustrating the hardware design of present handheld imaging device using concept 2 as an example in accordance with some embodiments of the present inventive concept(s).

FIG. 16 is a diagram illustrating a design of visible illumination and sensing of present handheld imaging device in accordance with some embodiments of the present inventive concept.

FIG. 17 is a diagram illustrating a design of near infrared laser illumination and sensing of present handheld imaging device in accordance with some embodiments of the present inventive concept.

FIG. 18 is a diagram illustrating the design of target distance sensor and motion sensor of present handheld imaging device in accordance with some embodiments of the present inventive concept.

FIG. 19 is a diagram illustrating a design of temporal synchronization and spatial alignment of multispectral images for present handheld imaging device in accordance with some embodiments of the present inventive concept.

FIGS. 20A through 20D are diagrams illustrating the design of a hardware platform to facilitate spatial alignment of multispectral images and beam profile testing for present handheld imaging device in accordance with some embodiments of the present inventive concept.

FIG. 21 is a block diagram illustrating a data processing system in accordance with some embodiments of the present inventive concept.

### DETAILED DESCRIPTION OF EMBODIMENTS

Embodiments of the present inventive concept will now be described more fully hereinafter with reference to the accompanying figures, in which some embodiments of the inventive concept are shown. This inventive concept may, however, be embodied in many different forms and should not be construed as limited to the embodiments set forth herein. Like numbers refer to like elements throughout. In the figures, layers, regions, elements or components may be exaggerated for clarity. Broken lines illustrate optional features or operations unless specified otherwise.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the inventive concept. The sequence of operations (or steps) is not limited to the order presented in the claims or figures unless specifically indicated otherwise.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

As will be appreciated by one of skill in the art, embodiments of the present inventive concept may be embodied as a method, system, data processing system, or computer program product. Accordingly, the present inventive concept may take the form of an embodiment combining software and hardware aspects, all generally referred to herein as a “circuit” or “module.” Furthermore, the present inventive concept may take the form of a computer program product on a non-transitory computer usable storage medium having computer usable program code embodied in the medium. Any suitable computer readable medium may be utilized including hard disks, CD ROMs, optical storage devices, or other electronic storage devices.

Computer program code for carrying out operations of the present inventive concept may be written in an object oriented programming language such as Matlab, Mathematica, Python, Java, Smalltalk, C or C++. However, the computer program code for carrying out operations of the present inventive concept may also be written in conventional procedural programming languages, such as the “C” programming language or in a visually oriented programming environment, such as Visual Basic.

Certain of the program code may execute entirely on one or more of a user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The inventive concept is described in part below with reference to flowchart illustrations and/or block diagrams of methods, devices, systems, computer program products and data and/or system architecture structures according to embodiments of the inventive concept. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer readable memory or storage that can direct a computer or other programmable data processing apparatus to function in a particular manner, such that the instructions stored in the computer-readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Most available AI/ML wound healing predictive models are based on visible color image or spectral bands which are insufficient in evaluating the wound healing process due to overlooking the important factors such as tissue blood flow and oxygen information. Accordingly, some embodiments of the present inventive concept provide an ideal platform to collect wound healing data and clinical feedback information as annotation for AI and ML training to build an accurate wound healing predictive assessment platform that can be integrated in the wound treatment procedure. It can transition multispectral soft tissue imaging from adjunct imaging technology to predictive analytical and diagnostic technology based on using large clinical database.

Some embodiments of the present inventive concept provide several light source designs for multispectral illumination. The method includes modular design for emitting each band of wavelength which can include free space optics, or fiber optics coupling with light source such as lasers, LEDs etc. Each band of wavelength can be coherent, or non-coherent depending on optical physics principle of the specific imaging modality. Other optics characters of each band of wavelength such as power, pulsing, and irradiance/flux can be adjusted depending on the imaging application.

Some embodiments of the present inventive concept provide several camera designs for multispectral sensing. The method includes modular design for detecting each band of wavelength which can include reflected light or emission light of fluorescence and autofluorescence. The designs can include multiple-camera, multi-sensor or single sensor with multispectral pixels or single sensor to detect each band of wavelength at a different time. The spectral regions of illumination and detection include UV (100-400 nm), Visible (400-700 nm), and NIR (700-1000 nm).

Some embodiments of the present inventive concept implement mathematical equations, software algorithms, and programs. The software architecture is optimized based on selected multispectral illumination and camera sensing designs. Software flowchart includes pre-imaging, image acquisition, processing, feature abstraction, AI-ML modeling and analysis, visualization, and reporting.

Some embodiments of the present inventive concept provide integration of a list of imaging modalities based on selected multispectral illumination and camera sensing designs. Imaging modalities in a medical device include, for example, broadband, narrowband, fluorescence, autofluorescence, Laser Speckle Imaging (LSI), Laser Doppler Imaging (LDI), tissue oxygenation imaging, and other variations of soft tissue imaging functions.

Some embodiments of the present inventive concept provide optimization of deep learning-based analysis to achieve image enhancement, segmentation, classification, and feature detection using convolutional neural network (CNN) and its variations.

Some embodiments of the present inventive concept provide design adaptability and options of form factor. The device can be designed as an addon to smart phones, tablets including illumination, sensing, and control units. The mobile devices are used to provide computational, display, storage, internet access units and possibly visible illumination and sensing units. The device can also be designed as an independent portable device using its own computational engine such as SOM. Form factors include handheld device, tablet device used on a table, and detachable device from medical towers as will be discussed further herein.

Human organs are composed of different types of soft and hard tissues. The soft tissues have complex structures and compositions. As the largest organ of the human body, for example, skin possesses a layered structure of multiple tissues that include epidermis, dermis and hypodermis. The skin dermis consists of connective tissues, blood, endothelium and subendothelial connective tissues of blood vessels, fat, etc. Current wound triage is first done visually by the health care professional or emergency worker. Studies have shown that this initial visual assessment is roughly 50% accurate for frontline and emergency workers and 70% accurate for wound and burn specialists. Utilizing this new imaging technology will enhance this accuracy in every healthcare setting, from treatment of chronic wounds in Diabetics to assessment of blast injuries on the battlefield.

Multispectral technology utilizes illumination beyond visible band such as ultraviolet (UV) (300-400 nm) and near infrared (NIR) (700-1000 nm) to gain new information not only of the anatomical structure of the tissue but more importantly functional characteristics of the tissue physiology. The present inventive concept refines multispectral technology by synchronizing all imaging channels temporally (alignment of time stamps) and spatially (alignment of pixels) and broaden multispectral platform by combining a wide range of illuminations and camera sensors to achieve this synchronization purpose. The present inventive concept also adds various imaging modalities on the multispectral platform and each modality generates its own featured imaging result different than the raw images such as blood flow and perfusion, oxygenation, and fluorescence maps. To transition multispectral technology from adjunct imager to predictive and diagnostic device, deep learning models are built on clinically backed data for wound classification and segmentation that is consistent with existing wound care practice. With the AI-ML model being trained by expert annotation, this method has the potential to optimize wound care workflow by making the expertise of a wound specialist available to every patient in need, while also providing customized care recommendations to best fit each case.

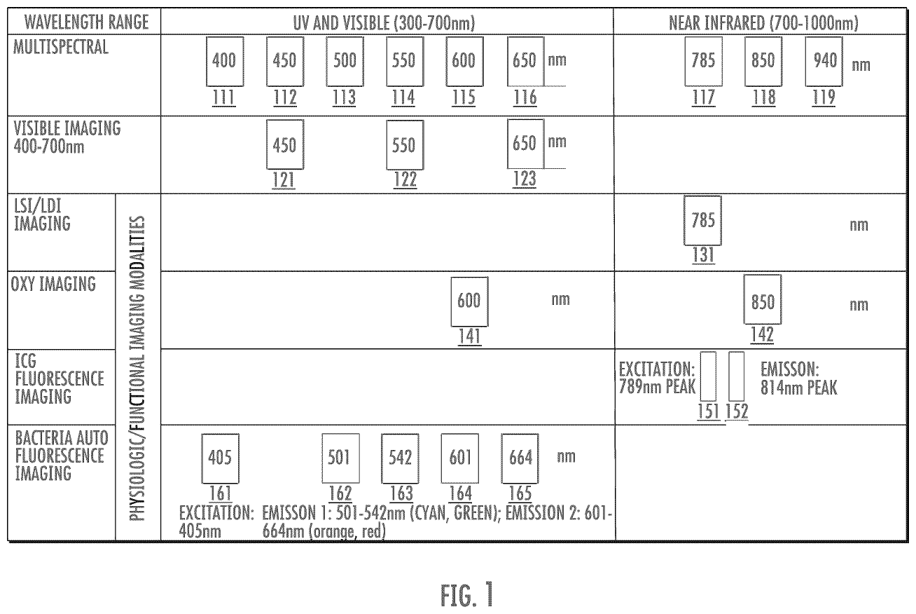

Referring first to FIG. 1, spectral range of the optical system based on multiple wavelength ranges/bands in UV, visible and NIR in accordance with some embodiments of the present inventive concept will be discussed. In UV and visible range, there are six wavelength ranges, and they are centered at 400 (112), 450 (112), 500 (113), 550 (114), 600 (115) and 650 nm (116). In the NIR range, there are three wavelength ranges, and they are centered at 785 (117), 850 (118) and 940 nm (119). Five imaging modalities can be added on the multispectral platform, and they are visible imaging modality including broad band (white light) imaging (400-700 nm) and narrow band imaging with any wavelength or combination of multiple wavelengths in the 400-700 nm range such as; Laser Speckle Imaging or Laser Doppler Imaging modality using for example 785 nm (131) coherent laser illumination; oxygenation imaging using for example 600 nm (141) noncoherent orange light in the visible range and 850 nm (142) noncoherent light in the NIR range; ICG fluorescence imaging modality using for example noncoherent NIR light peaked at 789 nm (151) as excitation and sensing emission peaked at 814 nm (152); bacteria auto fluorescence imaging modality using noncoherent UV light peaked at 405 nm (161) as excitation illumination sensing emission 501-542 nm (162, 163) and 601-664 nm (164, 165).

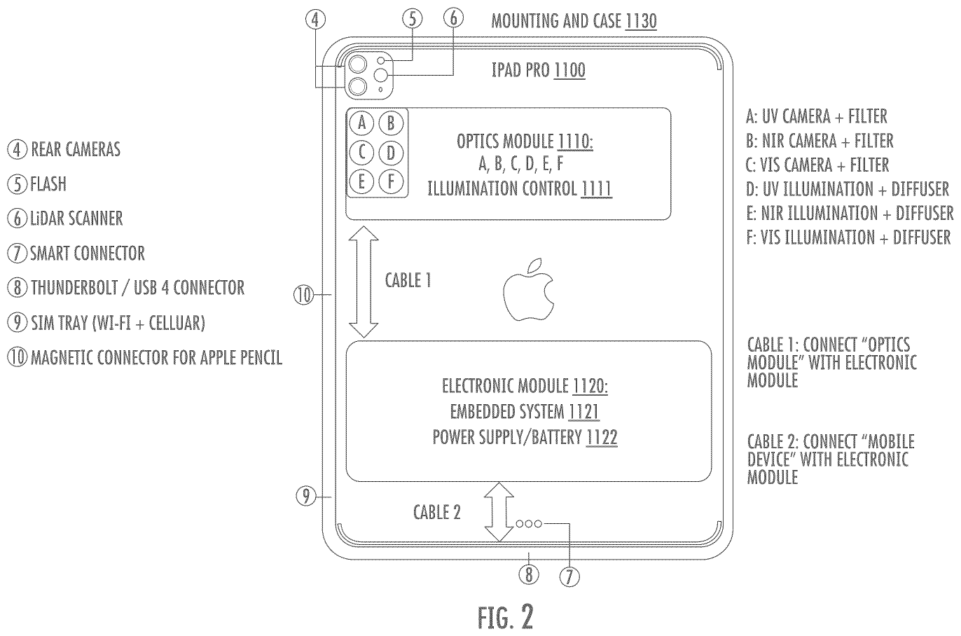

Referring to FIG. 2, a concept design of an addon multispectral imaging system to a mobile device (for example, iPad Pro) in accordance with some embodiments of the present inventive concept will be discussed. The optics module (1110) includes but is not limited to UV camera and filter (A), NIR camera and filter (B), visible camera and filter (C), UV illumination and diffuser array (D), NIR illumination and diffuser array (E), visible illumination and diffuser array (F) and illumination control board (1111) to drive the light source. The electronic module (1120) includes an embedded system (1121) for controlling cameras (A, B, C) and sending data to mobile device (1100) to process, and power supply (1122). The mounting and case (1130) hold mobile device (1100), optics module (1110) and electronic module (1120) together. The rear cameras (4) and flashlight (5) native to the mobile device (1100) can be also used for broadband visible color imaging. The USB 4 connector (8) native to the mobile device (1100) is used for interfacing with the electronic module (1120). If a mobile device is not equipped with cameras and flash, camera with IR cut filter (C), and white/RGB LEDs (F) in the optics module (1110) can used for visible broad/narrow band imaging. The mobile device provides hardware for functions such as computational processing, display, and internet connection etc. The addon device provides multispectral illumination and camera sensing. The light source can be LEDs and lasers in various wavelength bands and illumination ports can be in various geometric arrangement/array depending on a specific imaging modality. The divergence angle of the illumination needs to match the angular FOVs of the cameras to produce homogenous light irradiance on the target plane. If lenses with different focal length and sensors of different size are used, the FOVs need to be pre aligned so the effective FOV is the same for all the cameras that are engaged.

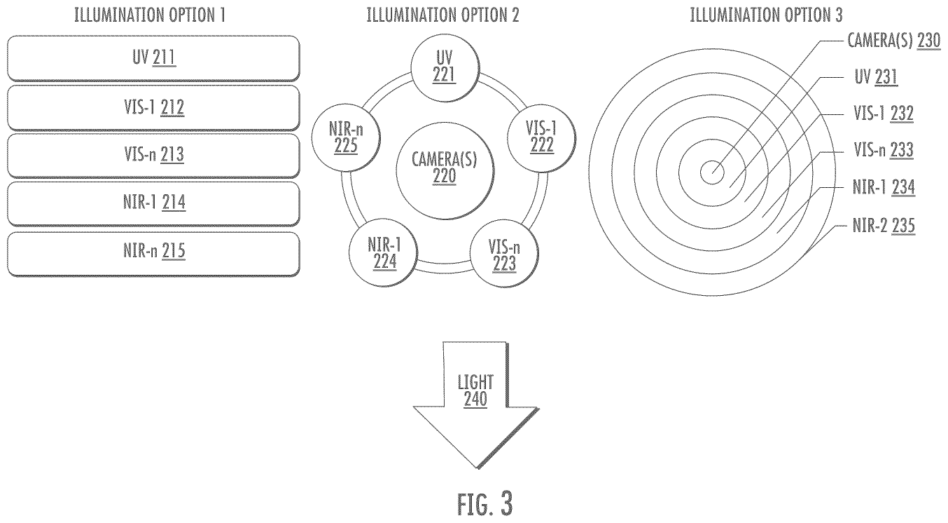

Referring to FIG. 3, three options of illumination layout in accordance with some embodiments of the present inventive concept will be discussed. Option 1 illustrates five illumination ports in parallel as UV band (211), visible band 1 (212), visible band 2 (213), NIR band 1 (214), and NIR band 2 (215). Option 2 illustrates five single illumination ports arranged symmetrically around one or multiple camera lenses (220) as UV band (221), visible band 1 (222), visible band 2 (223), NIR band 1 (224), and NIR band 2 (225). Option 3 illustrates five illumination ring ports arranged around the center of one or multiple camera lenses (230) as UV band (231), visible band 1 (232), visible band 2 (233), NIR band 1 (234), and NIR band 2 (235). The multispectral light (240) is emitted from the illumination device toward the target. Number of the wavelength bands may include but not limited to five and geometric arrangement of the wavelength bands may include but not limited to options 1-3.

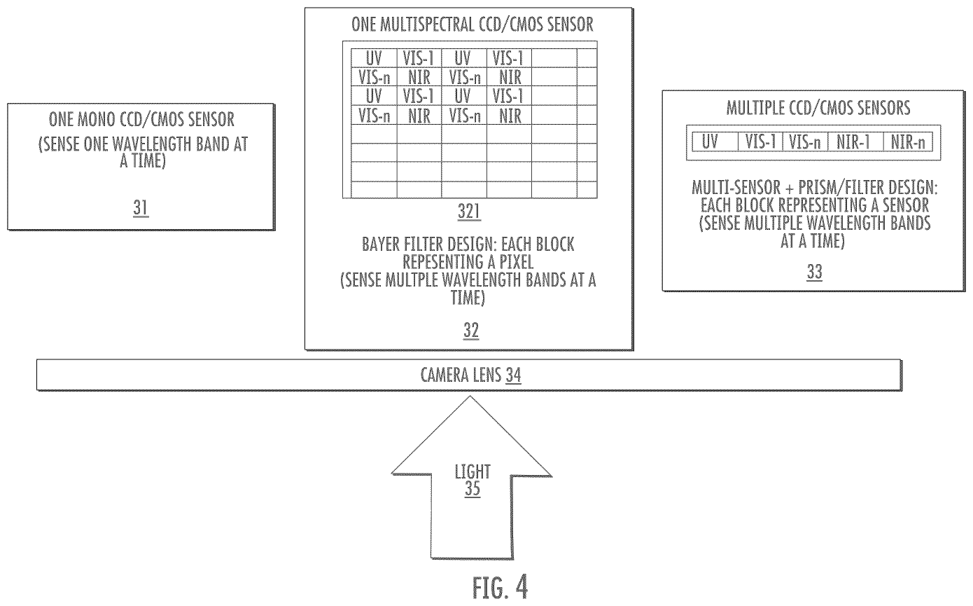

Referring to FIG. 4, three options of camera sensing design in accordance with some embodiments of the present inventive concept will be discussed. Option 1 illustrates one mono CCD or CMOS sensor (31) is used with camera lens (34) to capture the reflected light (35) of one wavelength band at a time and by realigning the time stamps associated with the frames, live videos from multiple imaging channels can be semi temporally synchronized and fully spatially synchronized. Option 2 illustrates one multispectral CCD or CMOS sensor (32) is used with camera lens (34) to capture all the reflected/emission wavelength bands at the same time and by coating the sensor with a customized Bayer filter (321) with each pixel is only sensitive to a specific wavelength band. Through a Demosaicing algorithm, live videos from multiple imaging channels can be fully temporally synchronized and semi spatially synchronized. Option 3 illustrates multiple CCD or CMOS sensors (33) are used with camera lens (34) to capture all the reflected/emission wavelength bands at the same time and with prism separating light into multiple wavelength bands or optical paths, live videos from multiple imaging channels can be fully temporally synchronized and fully spatially synchronized. A practical design can be a combination of the three options depending on a specific application. For example, a two-sensor camera can have one sensor as RGB Bayer filter design to capture visible band and the other sensor as multispectral sensor capable of detecting two NIR wavelength bands.

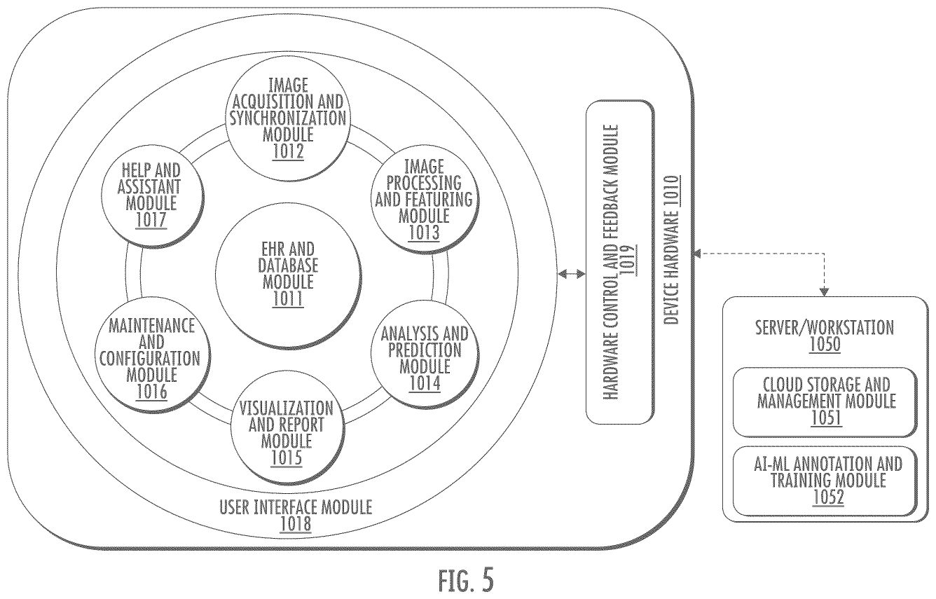

Referring to FIG. 5, major software modules in accordance with some embodiments of the present inventive concept will be discussed. The mobile device provides an operating system and software development kit for programming a customized imaging app. The software designed for the mobile device includes database module (1011) for saving parameter setting, imaging data and interfacing with electronic health record system in the hospital; image acquisition and synchronization module (1012) for acquiring multi-channel images and align each frame temporarily and spatially; image processing and featuring module (1013) for processing images allocated for a specific imaging modality; analysis and prediction module (1014) for image enhancement, classification and segmentation by inputting multi-channel images and processed feature images into a pre-trained AI-ML model; visualization and report module (1015) for generating a fused display with multiple layers; maintenance and configuration module (1016) for hardware monitoring, optics calibration, and saving parameter setting; help and assistant module (1017) for providing ease of use guidance through visual and audio assistance; hardware control and feedback module (1019) for communicating with hardware including mobile device and addon device.

Image acquisition and synchronization module (1012) can also perform real time FOV alignment if multiple cameras are used and variation of target distance causes inaccuracy of the pre alignment setting. Image processing and featuring module (1013) can perform real time calculation for each imaging modality using CPU and/or GPU. The motion artifact can be minimized by identifying the time frame of minimal motion through image registration, optical flow, and accelerometer feedback and calculating a snapshot result or a short sequence of video. Visualization and report module (1015) uses image fusion technique and can visualize tissue anatomical layer (visible color image), tissue physiology layer (LSI/LDI, oxygenation, fluorescence, autofluorescence images), tissue segmentation layer (using wound image as an example: minor burn, partial-thickness burn, full-thickness burn) and measurement/labeling layer (using wound image as an example: wound size measurements). The program designed outside the mobile device can run on a server or workstation (1150) includes cloud storage and management module (1051) for backing up parameter setting and imaging data uploaded from the mobile device and providing update of application software; the AI-ML annotation and training module (1052) for generating clinical annotation on the images as Ground Truth and using that information to train a deep learning model.

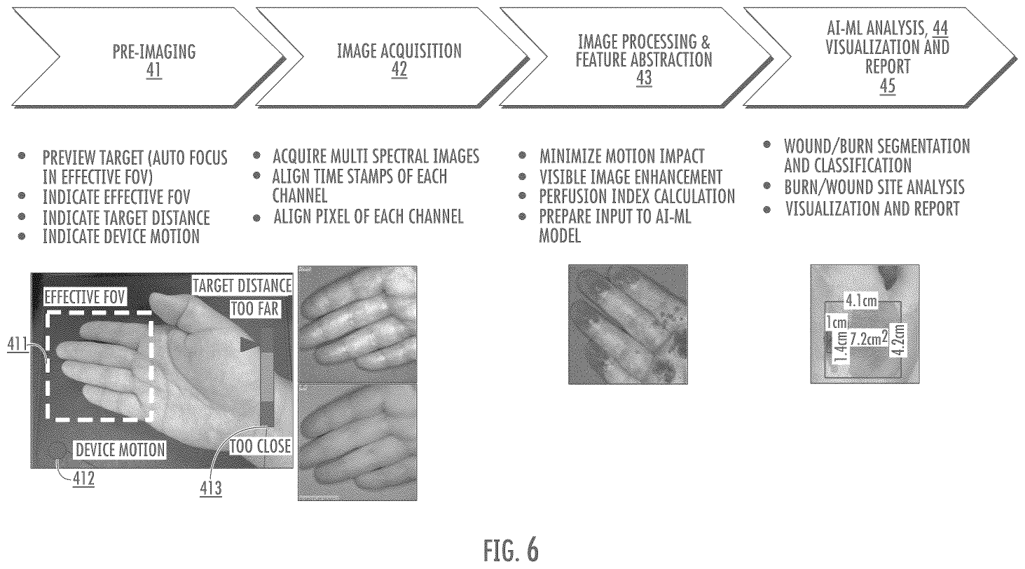

Referring to FIG. 6, an image data processing flow chart in accordance with some embodiments of the present inventive concept will be discussed. Pre-imaging process (41) includes but is not limited to functions of previewing target, indicating effective FOV (411), indicating target distance (413), indicating device motion (412). Image acquisition process (42) includes but is not limited to functions of synchronizing illumination and camera sensing, aligning time stamps of each channel, and aligning pixel of each channel. For example, visible (421) and NIR (422) channels of a human hand are captured in a temporally and spatially synchronized fashion. Image processing & feature abstraction process (43) includes but is not limited to calculating and enhancing feature images such as broad band imaging, narrow band imaging, LSI/LDI imaging (431), oxygenation imaging (432), fluorescence/auto fluorescence imaging. AI-ML analysis process (44) includes but is not limited to functions of acquiring annotation for Ground Truth, model selection and training, model evaluation and optimization, image classification, segmentation, and prediction. Visualization & reporting process (45) includes but is not limited to functions of generating fused image with tissue anatomical structure layer, tissue functional physiology layer, analytical result layer, tissue feature measurement, and labeling layer. Use a burned case (451) as an example, one layer visualizes anatomical structure of a human hand using visible color image; another layer visualizes burn categories (green color indicates 1^{st} degree burn, purple color indicates 2^{nd} degree burn); the third layer visualizes the size measurement of the burn.

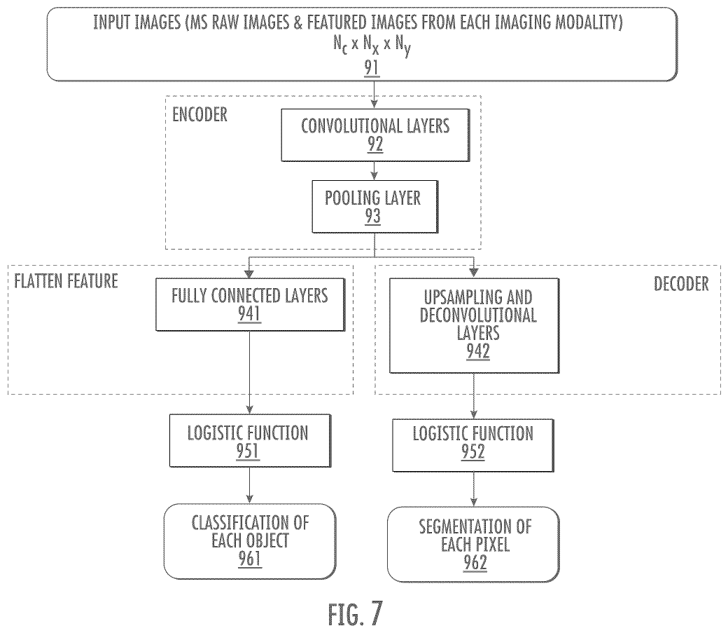

Referring to FIG. 7, an architecture of convolutional neural network for image classification and segmentation in accordance with some embodiments of the present inventive concept will be discussed. Convolutional Neural Network (CNN) is a type of deep learning algorithm used for analyzing and processing data that has a grid pattern, and it is commonly used in image classification and segmentation. Although layers of each specific network differ from another, CNN and its variations share similar structure. In the present inventive concept, input images (91) are comprised of a 3D matrix N_{c}×Nₓ×N_{y} with Nₓ and N_{y} being number of pixels along width and height of an image and N_{c} is the number of image channels. For example, if multispectral platform captures visible color image and LSI image, the number of raw image channels will be four (3 RGB visible channels and one NIR channel). Furthermore, if the NIR channel is used to generate perfusion information through LSI calculations, there will be additional two channels with one being the average flow information (DC component) and one being pulsatile flow information (AC component). Therefore, all five channels can be used as input into the CNN network. The first sequence of layers are convolutional (92) layers to extract local features and pooling (93) layers to reduce spatial dimensions and they also serve as encoder in fully convolutional network (FCN). If the output is multiple classes (961), fully connected layers (941) are used to convert the multi-dimensional pooled feature map into one dimensional vector and feed into a traditional neural network. Logistic functions (951) such as ReLu, SoftMax are used to decide which category a feature should belong to. If the goal is image segmentation (962) which categorizes each pixel into a class, up-sampling and deconvolutional layers (942) also known as decoder are used to generate the full dimension feature map. With the same token as image classification, logistic functions (952) are used to decide which category a pixel should belong to. For ML programming using Matlab, Pytorch, TensorFlow etc., the input will be divided into batches to reduce the consumption of hardware resource and the learning algorithm will work through the entire dataset for a number of epochs to update model parameters based on a specific gradient decent strategy.

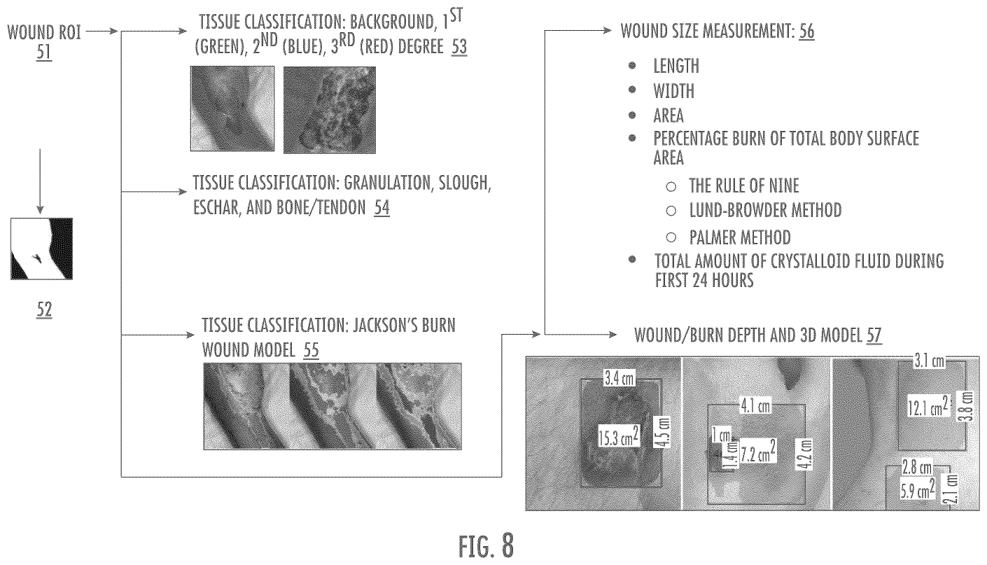

Referring to FIG. 8, a workflow of multispectral image analysis in wound care application in accordance with some embodiments of the present inventive concept will be discussed. A region of interest ROI with target tissue in center (51) is selected and multi-channel images within the ROI are used as input to a deep learning model. First, tissue is separated from non-tissue background (52) using color and/or perfusion map as criteria. Based on wound depth features, pixels in the ROI can be segmented into categories such as minor burn, partial-thickness burn, and full-thickness burn (53). Based on wound color features, pixels in the ROI can be segmented into categories such as granulation, slough, eschar, and bone/tendon (54). Based on wound perfusion and oxygenation features, pixels in the ROI can be segmented into zones such as coagulation, statis/ischemia, and hyperemia (55). Furthermore, based on the segmentation result wound size (56) such as length, width, and area can be measured and other parameters such as percentage burn of total body surface area and total amount of crystalloid fluid during first 24 hours can be calculated using additional information such as patient age, weight, height etc. 3D wound model (57) can be reconstructed using size measurement and penetration information and topographic information of wound bed using sensor such as LiDAR Scanner.

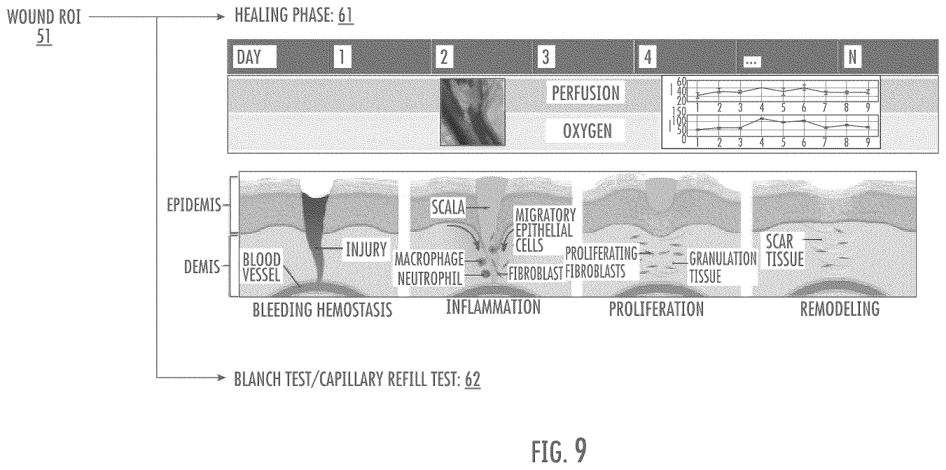

Referring to FIG. 9, continuation of workflow of multispectral image analysis in wound care application in accordance with some embodiments of the present inventive concept will be discussed. The wound healing process can be divided into four separate stages: hemostasis, inflammation, proliferation, and remodeling. In general, the perfusion level increases in phase 2 and 3 due to angiogenesis process and decreases in phase 4 during coalescence. If a wound bed is continuously imaged during the wound healing process, this incline and decline trend can be observed in the perfusion and oxygenation curve (61). Combined with changes of size measurement of a wound category, this information can be used to predict the healing status and time required. Furthermore, with multispectral imaging technology a blanch test/capillary refill test can be done in a non-contact fashion.

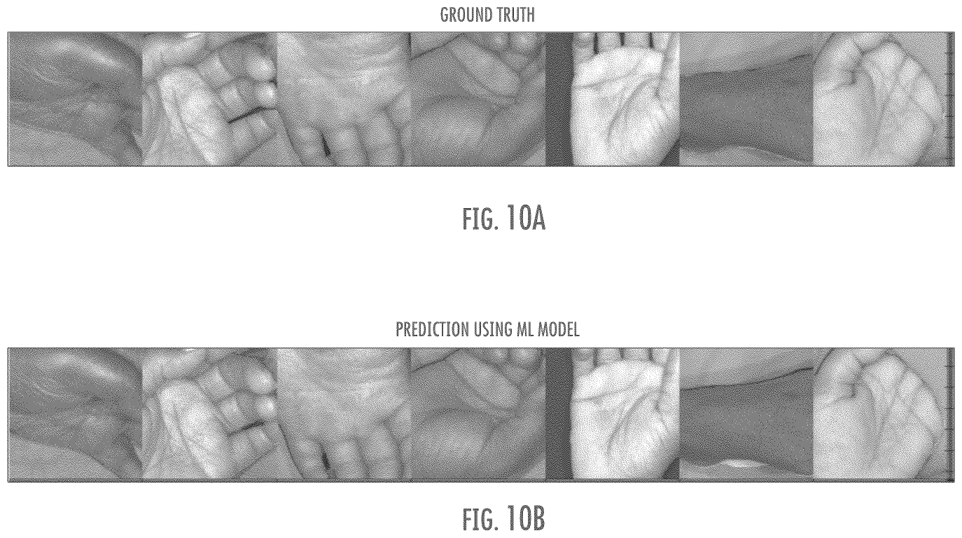

Referring to FIGS. 10A and 10B, an example of machine learning driven tissue separation from non-tissue background in accordance with some embodiments of the present inventive concept will be discussed. FIG. 10A is the ground truth information labeling the background as blue color and tissue (human hands and foot) as natural color. A CNN model is trained with 60 4-channel images (RGB-Average Perfusion Map) as input and output pixels are categorized into two classes (tissue, background). FIG. 10B is the prediction result with background highlighted in blue color.

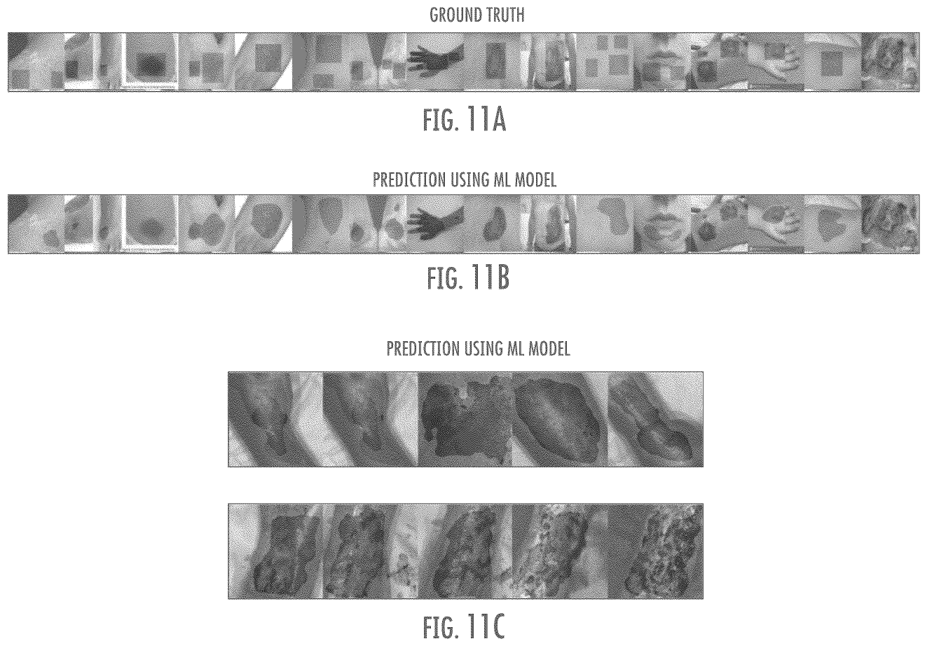

Referring to FIGS. 11A through 11Cn example of machine learning driven burn segmentation in accordance with some embodiments of the present inventive concept will be discussed. FIG. 11A is ground truth information labeling first degree (green box), second degree (purple box), and third degree burn (red box) using public source. A CNN model is trained with 500 3-channel images (RGB) as input and output pixels are categorized into four classes (background, 1^{st}, 2^{nd}, 3^{rd} degree burn). FIG. 11C is the prediction result with burn segmented in these three different colors.

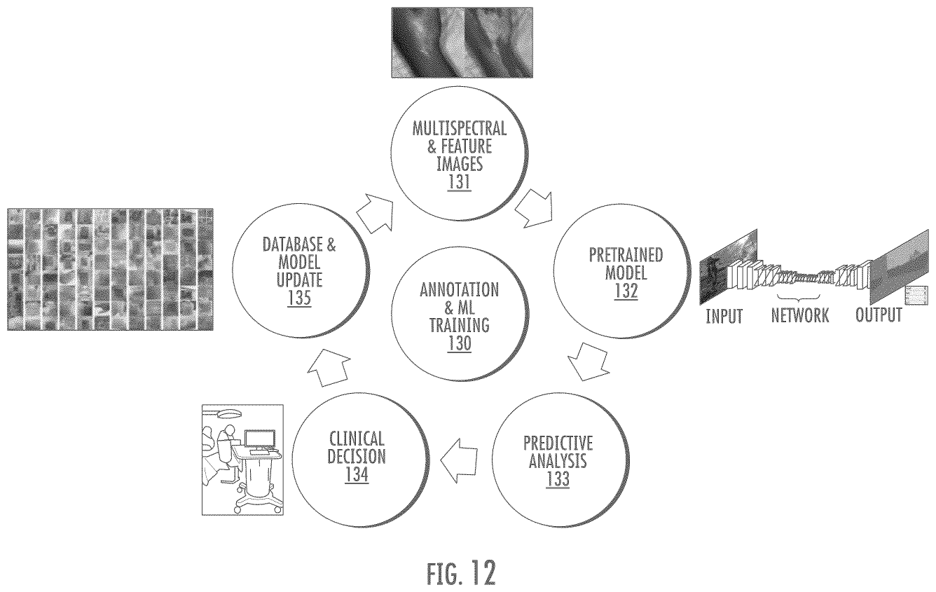

Referring to FIG. 12, an example of machine learning driven burn segmentation in accordance with some embodiments of the present inventive concept will be discussed. Using a pre-trained FCN model and 10 6-channel images (RGB-NIR-Average Perfusion MAP-Pulsatile Perfusion Map) as input and output pixels are categorized into four classes (background, 1^{st}, 2^{nd}, 3^{rd} degree burn).

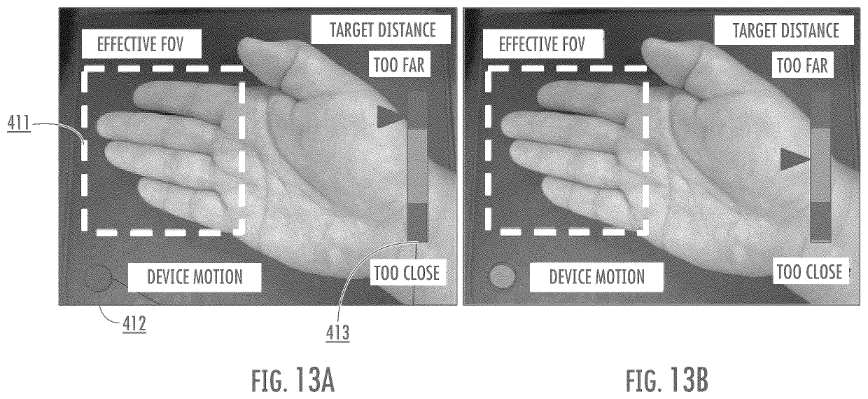

Referring to FIGS. 13A and 13B, an example of clinical workflow using machine learning driven multispectral image analysis in accordance with some embodiments of the present inventive concept will be discussed. Through annotation and model training process (130), a pretrained deep learning model (132) is generated and preloaded in a handheld imaging device (1100-1130). Multispectral images are captured, and feature images based on imaging modalities such as LSI, LDI, Oxygenation, fluorescence are generated during wound clinics (131). All the imaging results are fed into a pretrain model (132) to be analyzed and generate measurement and predictive results (133) such as wound types (53-55), wound measurement (56-57), wound status (61) which will be used in clinical decision-making process (134). The imaging database (135) will be updated each time the device being used and annotation being corrected as needed to optimize the training model parameters and improve the precision level for the next usage.

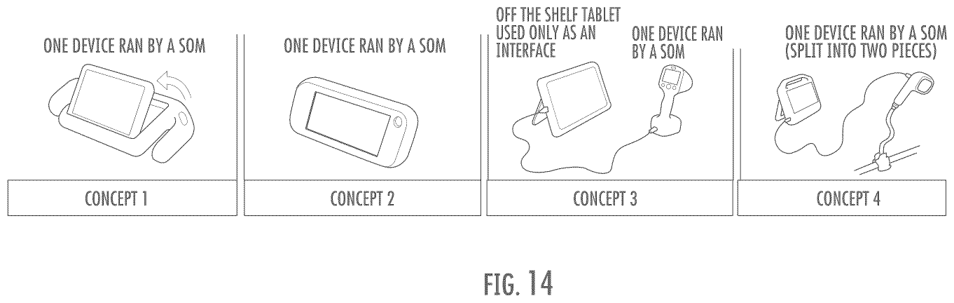

Referring to FIG. 14, four concept designs of potential form factors of present handheld imaging device are illustrated. Concept 1 has a tiltable touch screen that can rotate within certain range on the main body, two handles on each side of the main body, an imaging button beside the right handle where an operator's thumb can easily press, and optical hardware and batteries are in the main body connected to the screen. Concept 2 is a more integrated design like a mobile tablet device highlighting its simplicity and compact features. Concept 3 allows separation of the imaging and display units. It uses a generic touch screen monitor for user input and visualization and uses a smaller battery powered handheld imaging unit to aim at the target. The display and imaging units can be connected using a USB and HDMI cables for data transfer and control. There are batteries and a smaller screen in the imaging unit allowing it to operate as an independent device. Concept 4 is like concept 3 but without batteries in the imaging unit therefore further reduce its size but it must be plugged into an external power supply to operate.

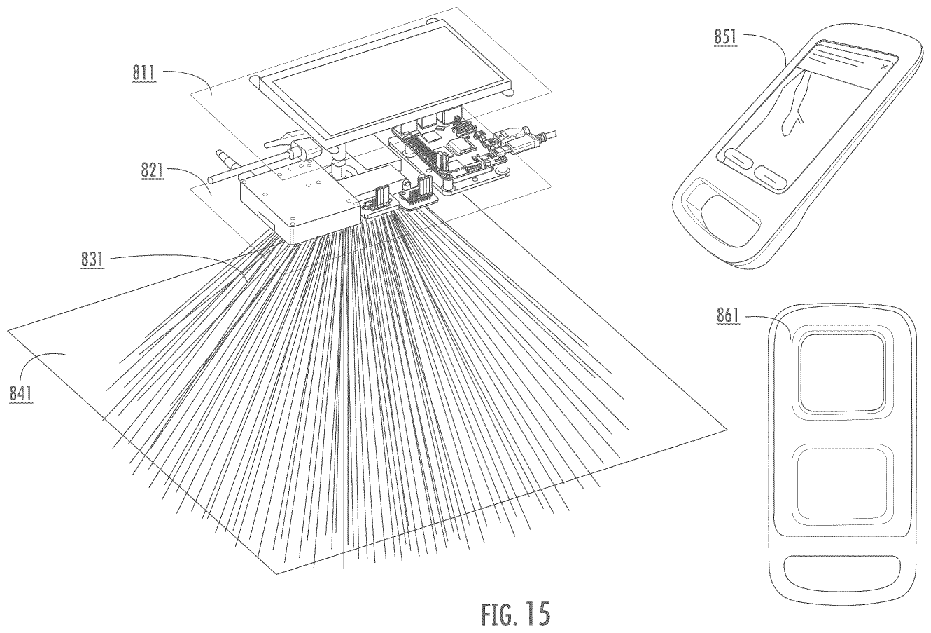

Referring to FIG. 15, this is a detailed design drawing with major optical and computing components included based on concept design 2. Major components are installed on two mounting planes and 811 is the mounting plane for the touch screen monitor and 821 is the mounting plane for the optical and computing components including visible illumination and sensing, NIR illumination and sensing, distance sensor, motion sensor and system-on-module (SOM) such as Raspberry Pi, NVIDIA Jetson Nano, or mobile phone/tablet computer. 831 represents visible rays (400-700 nm) emitted from visible LEDs and NIR rays (700-1000 nm) emitted from NIR coherent laser for LSI imaging or NIR LEDs for SpO2 imaging. 841 is the target plane on which visible beam covers the visible camera's FOV and NIR beam covers the NIR camera's FOV. 851 and 861 illustrate the enclosure of the present imaging device that packages 811 and 821 inside with touch screen on the front and illumination ports and cameras on the back.

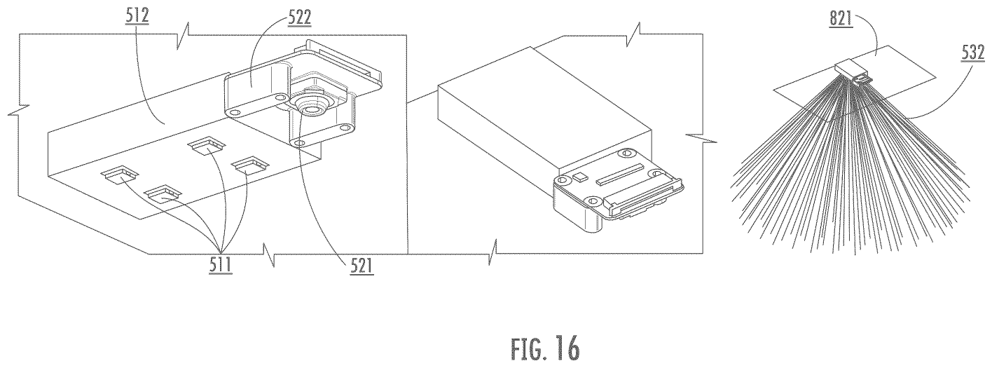

Referring to FIG. 16, this is a detailed design drawing with major components of visible illumination and sensing module. 511 is a visible LED array including N separate RGB or White LED chips (400-700 nm) and 512 is the LED driver providing high current and low voltage power supply for each LED chip (for example 1A and 5V). The LED driver can also pulse the LED chip with programmable cycle duty and synchronize with a board camera 521 which has a autofocus micro lens and transfers imaging data through MIPI-CSI2 interface or USB 3.X interface to the computer (for example Raspberry Pi camera module 3). 522 is the camera mounting block that can secure the camera on the optical reference plane 821 and 532 is the visible beam that is typically shaped as a cone. The size of the visible beam on the target plane is controlled by the divergence angle of the LED chip, LED array arrangement, and target distance. The LED chips can be configured with any illumination arrangement options in FIG. 3 to achieve intended irradiance distribution on the target.

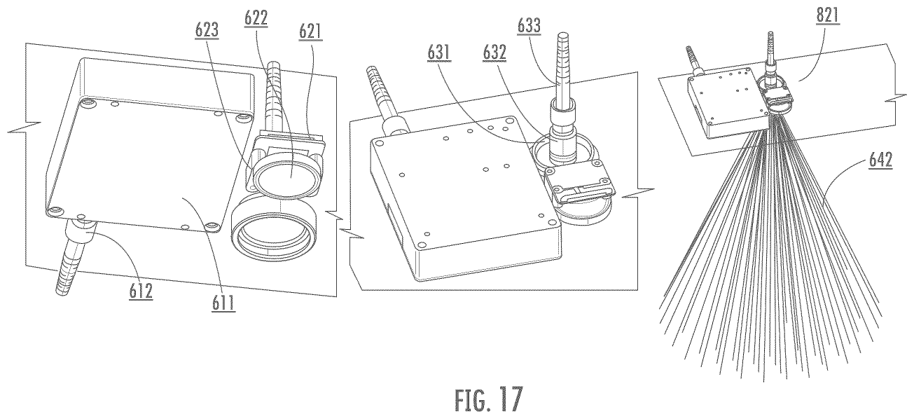

Referring to FIG. 17, this is a detailed design drawing with major components of NIR illumination and sensing module. 611 is a laser diode, driver, and electric thermal cooling enclosed in a box and 612 is the laser port connected with one end of a fiber. The other end of fiber 633 is connected to a collimator 632 and then to a diffuser 631. The collimator and diffuser work together to homogenize and expand the laser beam onto the target plane. The size of the NIR beam on the target plane is controlled by the divergence angle of the diffuser and target distance. 621 is a board camera with autofocus micro lens that transfers imaging data through MIPI-CSI2 interface or USB 3.X interface (for example Raspberry Pi camera module 3 NoIR). Camera 621 only detects NIR light with a bandpass filter 622 being installed in front of the lens or between lens and sensor to remove ambient light. 623 is the camera mounting block that can secure the camera on the optical reference plane 821 and 642 is the NIR beam that is typically shaped as a cone. All optical components are mounted and referenced to the same optical plane 821.

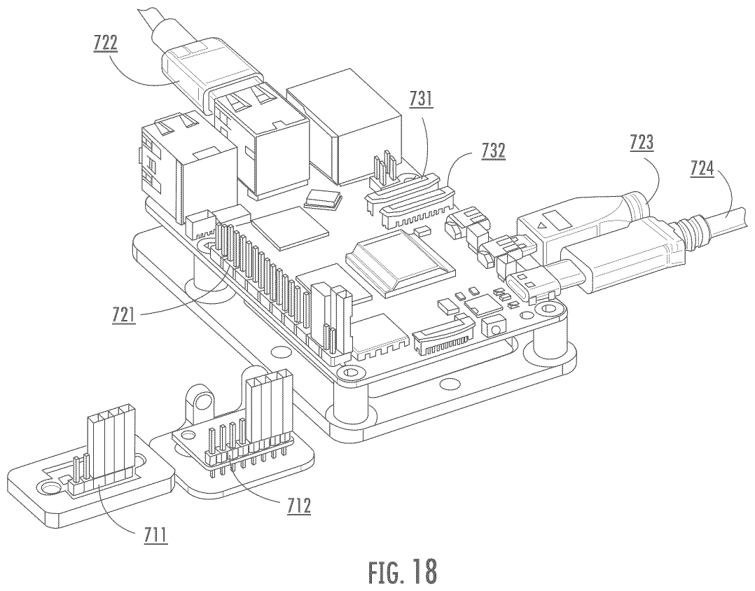

Referring to FIG. 18, this is a detailed design drawing of sensors and computational module. 711 is a Time-of-Flight (ToF) ranging sensor to detect distance between the optical plane 821 and target plane 841 and it communicates with the computational module using I2C protocol and it can also be powered by the computational module. 712 is a motion sensor to detect motion artifact and orientation of present handheld device, for example shaking caused by an operator and detecting if laser power faces downward before activating the laser. The motion sensor also communicates with the computational module using I2C protocol and it can also be powered by the computational module. The motion sensor can be a 3-axis gyroscope and/or a 3-axis accelerometer. The computational module can be any SOM device such as Raspberry Pi running an operating system such as Linux. It includes power supply port 724 such as USB-C, touch screen connection port 722 such as USB port, display connection port 723 such as micro-HDMI. It also includes multiple MIPI-CSI2 ports (731, 732) to connect with the visible and NIR cameras. Its GPIO interface is used to supply power and communicate with the distance sensor (711) and motion sensor (712).

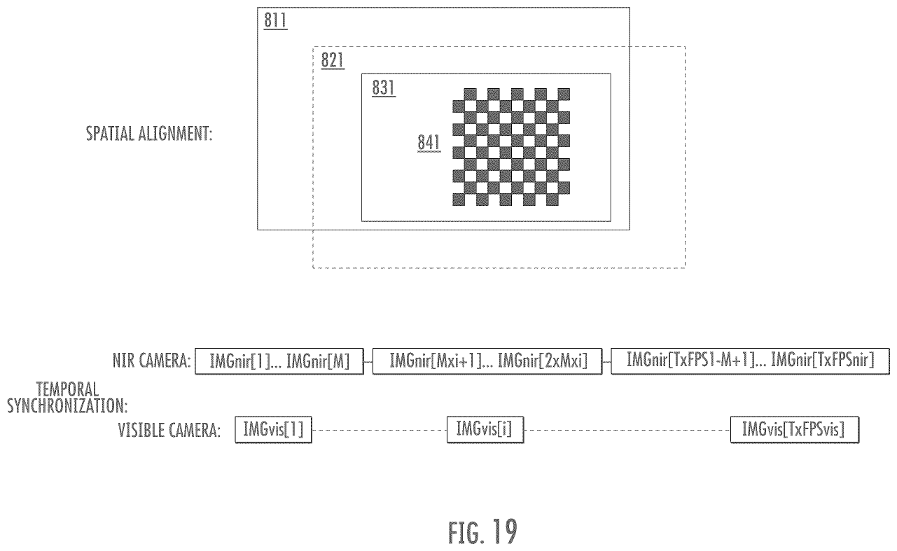

Referring to FIG. 19, this is a schematic illustrates the spatial alignment and temporal synchronization of images acquired by multiple cameras to achieve MSPV image process, predictive analysis and overlay visualization. Instead of using multi-sensor camera which aligns and synchronize images from different sensors internally, multiple independent cameras are used in this design to reduce the size of present handheld imaging device. Box 811 represents the FOV of the visible camera at its full resolution and box 821 represents the FOV of the NIR camera at its full resolution. The two boxes don't typically overlap due to factors such as offset of their optical axes, lens differences, resolution differences and sensor size differences etc. A common box 831 is selected through sensor cropping and pixel binning, and image registration techniques can facilitate automatic selection of the common FOV using a reference target of grid patterns 841. The alignment process generates pixel offset coordinate (x, y) and length, width of the new FOV for each camera sensor. Temporal synchronization of visible and NIR cameras are also critical for further image processing and overlay display especially for real time usage case. The temporal synchronization can be achieved through hardware or software mechanisms. Temporal synchronization through hardware includes a master pulse generator to drive the starting and ending time of each exposure of multiple cameras and on/off control of illumination. If both cameras share the same frame rate, one pulse train is sufficient and if each camera has its own frame rate, multiple pulse trains are required. Temporal synchronization through software includes reading time stamps of a common clock such as CPU time to log image acquisition or transfer time of each frame from multiple cameras and a timestamp to timestamp aligning algorithm after a sequence of frames are acquired. In general, hardware synchronization is more precise than software synchronization, but software synchronization is easier and more flexible to realize. Using two cameras synchronization as an example, T second images are acquired by both cameras with frame rate of FPSₙᵢᵣ and FPSᵥᵢₛ. If NIR camera has a higher frame rate than visible camera

$$\frac{{FPS}_{nir}}{{FPS}_{vis}} = M$$

every M frames of NIR camera IMGₙᵢₜ[M×i+1] . . .
IMGₙᵢᵣ[2×M×i] (i is the index of the bundle of M frames) corresponds to one frame of visible camera IMGᵥᵢₛ[i]. The timestamp of visible frame IMGᵥᵢₛ[i] should be the center time of M NIR frames bundle and when M=1 the frame rate of two cameras is the same, and M NIR frames reduces to one frame IMGₙᵢᵣ[i].

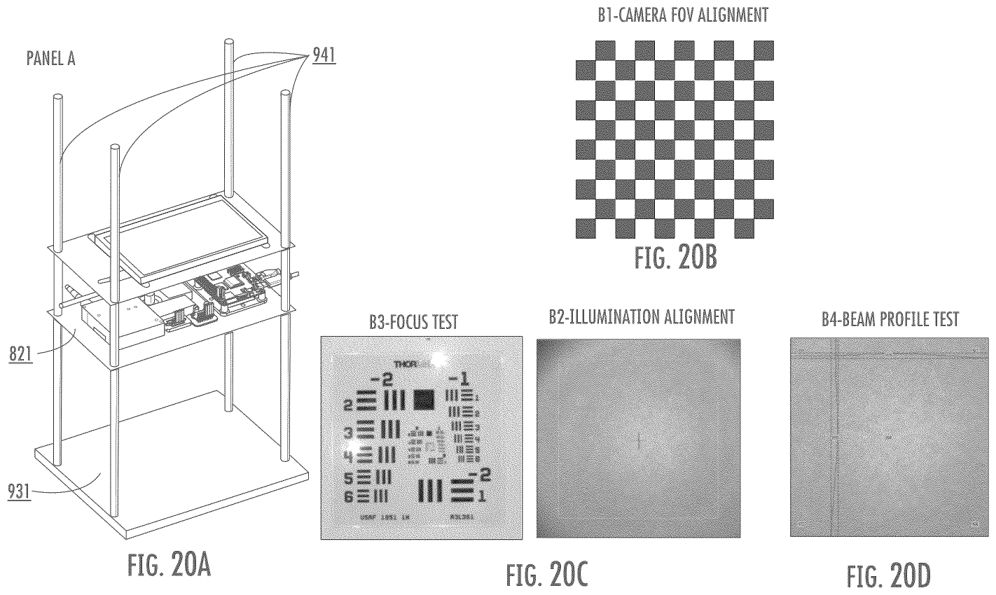

Referring to FIG. 20A—Panel A, this is a detailed design drawing of calibration platform for spatial alignment of camera FOV, illumination area, focus test and beam profile test. 821 is an optical reference/mounting plane that secure multiple cameras and illumination ports on it and it slides up and down along 4 poles (941) to adjust the target distance target distance. The target plane (931) is designed to locate alignment targets and perform optical tests. FIG. 20B—Panel B1 illustrates a black, and white grids target to align FOVs of multiple cameras through defining an area on the camera sensor using parameters such as offset, width, length. The alignment process is guided by custom software using image registration techniques. FIG. 20C—Panel B2 illustrates a mechanism to use diffuse reflector as target to align the FOV of a camera and its corresponding illumination beam by adjusting the location, tilting, and divergence angle of the illumination port. Bright circle represents illumination area with dark corners being unilluminated and yellow square represents FOV of the camera. FIG. 20C—Panel B3 illustrates a focus target to test if all the cameras are properly focused by differentiating two adjacent lines in the corresponding spatial resolution category. FIG. 20D—Panel B4 illustrates a mechanism to display beam profile imaged by a camera using a diffuse reflector as target. Custom software is used to examine minimum and maximum irradiance and their variation along horizonal and vertical directions.

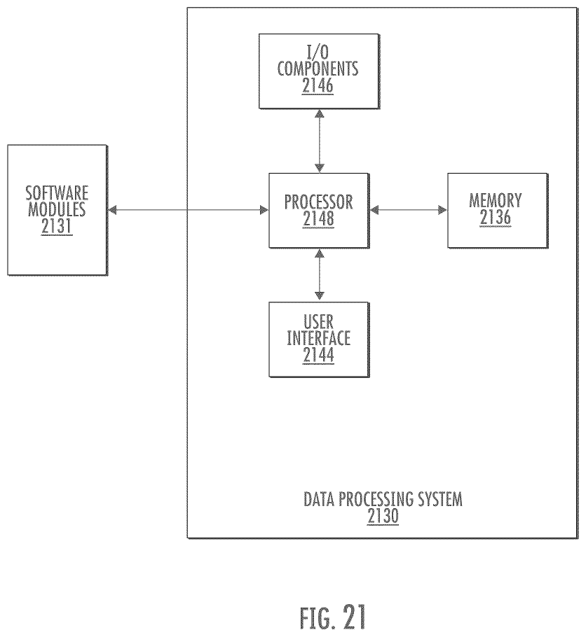

Referring now to FIG. 21, an example of a data processing system 2130 suitable for use with any of the examples described above. Although the example data processing system 2130 is shown as in communication with the software modules 2131 in accordance with embodiments of the present inventive concept, the data processing system 2130 may also be part of the routing module 2195 or in any other component of the system without departing from the scope of the present inventive concept. In some examples, the data processing system 2130 can be any suitable computing device for performing operations according to the embodiments discussed herein described herein.

As illustrated, the data processing system 2130 includes a processor 2148 communicatively coupled to I/O components 2146, a user interface 2144 and a memory 2136.

The processor 2148 can include one or more commercially available processors, embedded processors, secure processors, microprocessors, dual microprocessors, multi-core processors, other multi-processor architectures, another suitable processing device, or any combination of these. The memory 2136, which can be any suitable tangible (and non-transitory) computer-readable medium such as random-access memory (RAM), read-only memory (ROM), erasable and electronically programmable read-only memory (EEPROMs), or the like, embodies program components that configure operation of the data processing system 2130.

I/O components 2146 may be used to facilitate wired or wireless connections to devices such as one or more displays, game controllers, keyboards, mice, joysticks, cameras, buttons, speakers, microphones and/or other hardware used to input or output data. Memory 2136 represents nonvolatile storage such as magnetic, optical, or other storage media included in the data processing system and/or coupled to processor 2148.

The user interface 2144 may include, for example, a keyboard, keypad, touchpad, voice activation circuit, display or the like and the processor 2148 may execute program code or instructions stored in memory 2136.

It should be appreciated that data processing system 2130 may also include additional processors, additional storage, and a computer-readable medium (not shown). The processor(s) 2148 may execute additional computer-executable program instructions stored in memory 2136. Such processors may include a microprocessor, digital signal processor, application-specific integrated circuit, field programmable gate arrays, programmable interrupt controllers, programmable logic devices, programmable read-only memories, electronically programmable read-only memories, or other similar device.

The aforementioned flow logic and/or methods show the functionality and operation of various services and applications described herein. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor in a computer system or other system. The machine code may be converted from the source code, etc. Other suitable types of code include compiled code, interpreted code, executable code, static code, dynamic code, object-oriented code, visual code, and the like. The examples are not limited in this context.

If embodied in hardware, each block may represent a circuit or a number of interconnected circuits to implement the specified logical function(s). A circuit can include any of various commercially available processors, including without limitation an AMD® Athlon®. Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Other types of multi-core processors and other multi-processor architectures may also be employed as part of the circuitry. According to some examples, circuitry may also include an application specific integrated circuit (ASIC) or a field programmable gate array (FPGA), and modules may be implemented as hardware elements of the ASIC or the FPGA. Further, embodiments may be provided in the form of a chip, chipset or package.

Although the aforementioned flow logic and/or methods each show a specific order of execution, it is understood that the order of execution may differ from that which is depicted. Also, operations shown in succession in the flowcharts may be able to be executed concurrently or with partial concurrence. Further, in some embodiments, one or more of the operations may be skipped or omitted. In addition, any number of counters, state variables, warning semaphores, or messages might be added to the logical flows or methods described herein, for purposes of enhanced utility, accounting, performance measurement, or providing troubleshooting aids, etc. It is understood that all such variations are within the scope of the present disclosure. Moreover, not all operations illustrated in a flow logic or method may be required for a novel implementation.

Where any operation or component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages. Software components are stored in a memory and are executable by a processor. In this respect, the term “executable” means a program file that is in a form that can ultimately be run by a processor. Examples of executable programs may be, for example, a compiled program that can be translated into machine code in a format that can be loaded into a random access portion of a memory and run by a processor, source code that may be expressed in proper format such as object code that is capable of being loaded into a random access portion of a memory and executed by a processor, or source code that may be interpreted by another executable program to generate instructions in a random access portion of a memory to be executed by a processor, etc. An executable program may be stored in any portion or component of a memory. In the context of the present disclosure, a “computer-readable medium” can be any medium (e.g., memory) that can contain, store, or maintain the logic or application described herein for use by or in connection with the instruction execution system.

A memory is defined herein as an article of manufacture and including volatile and/or non-volatile memory, removable and/or non-removable memory, erasable and/or non-erasable memory, writeable and/or re-writeable memory, and so forth. Volatile components are those that do not retain data values upon loss of power. Nonvolatile components are those that retain data upon a loss of power. Thus, a memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random-access memory (SRAM), dynamic random-access memory (DRAM), or magnetic random-access memory (MRAM) and other such devices. The ROM may include, for example, a programmable read-only memory (PROM), an erasable programmable read-only memory (EPROM), an electrically erasable programmable read-only memory (EEPROM), or other like memory device.

The devices described herein may include multiple processors and multiple memories that operate in parallel processing circuits, respectively. In such a case, a local interface, such as a communication bus, may facilitate communication between any two of the multiple processors, between any processor and any of the memories, or between any two of the memories, etc. A local interface may include additional systems designed to coordinate this communication, including, for example, performing load balancing. A processor may be of electrical or of some other available construction.

It should be emphasized that the above-described embodiments of the present disclosure are merely possible examples of implementations set forth for a clear understanding of the principles of the disclosure. It is, of course, not possible to describe every conceivable combination of components and/or methodologies, but one of ordinary skill in the art may recognize that many further combinations and permutations are possible. That is, many variations and modifications may be made to the above-described embodiment(s) without departing substantially from the spirit and principles of the disclosure. All such modifications and variations are intended to be included herein within the scope of this disclosure and protected by the following claims.

In the specification, there have been disclosed embodiments of the inventive concept and, although specific terms are used, they are used in a generic and descriptive sense only and not for purposes of limitation. The following claim is provided to ensure that the present application meets all statutory requirements as a priority application in all jurisdictions and shall be construed as setting forth the scope of the present inventive concept.

1. A multispectral imaging system addon to a mobile device, the system comprising:
a multispectral illumination design that emits light of N different bands or ranges of wavelengths from 300 nm to 1000 nm;
a multispectral sensing design that images reflected/emission light of N different bands or ranges of wavelengths from 300 nm to 1000 nm; and
hardware and software adaptors that connect to a mobile device such that the mobile device is used for imaging processing, storage, display, and internet connectivity.

2. The system of claim 1, wherein the mobile device includes a white light emitting diode (LED) that provides one of the multispectral illumination sources and a visible camera that provides one of the multispectral sensing options.

3. The system of claim 1, wherein a custom software application is deployed on the mobile device to control illumination sources, cameras, acquire, process and display multispectral images.

4. A multispectral imaging system that performs visible imaging, Laser Speckle Imaging (LSI) and Oxygen Saturation Imaging (SpO2), the system comprising:
a multispectral illumination module that emits light of N different bands or ranges of wavelengths from 300 nm to 1000 nm using multiple LEDs and/or lasers;
a multispectral sensing module that images reflected/emission light of the N different bands or ranges of wavelengths from 300 nm to 1000 nm using multiple cameras;
hardware and software adaptors that connect with a SOM to use the SOM for imaging processing, storage, display, and internet connectivity.

5. The system of claim 4, wherein multiple cameras are temporally synchronized to produce images acquired at the same time and spatially aligned to produce images with a same FOVs.

6. The system of claim 4, wherein a software application is deployed on the SOM to control illumination sources, cameras, acquire, process and display multispectral images.

7. A pre-imaging design to locate a FOV on a target, ensure correct target distance and reduce device motion artifact, the design comprising:
a visually guided distance indicator based on Time-of-Flight (ToF) ranging sensor;
a visually guided device motion indicator based on 6-Axis MEMS Motion Sensors; and
a visually guided field of view indicator based on region of interest ROI.

8.-16. (canceled)
